(19) United States
(12) Patent Application Publication
(10) Pub. No.: US 2025/0373010 A1
(43) Pub. Date: Dec. 4, 2025

(54) SYSTEM COMBINATION COMPRISING AT LEAST TWO ELECTROLYSIS SYSTEMS AND A POWER SUPPLY SOURCE

(71) Applicant: Siemens Energy Global GmbH & Co. KG, München (DE)

(72) Inventors: Marvin Bendig, Zirndorf (DE); Sven Schumann, Wilhermsdorf (DE); Ulf-André Geck, Herzogenaurach (DE)

(21) Appl. No.: 18/874,130

(22) PCT Filed: Jun. 20, 2023
(86) PCT No.: PCT/EP2023/066711

§ 371 Date: Dec. 12, 2024

(30) Foreign Application Priority Data
Jun. 30, 2022 (DE) 10 2022 206 735.5

(51) Int. Cl. H02J 1/10; C25B 9/65; C25B 9/70; H02J 1/14

(52) U.S. Cl. CPC H02J 1/102; C25B 9/65; C25B 9/70; H02J 1/14; H02J 2300/24; H02J 2300/28; H02J 2310/18

(57) ABSTRACT

A system combination having at least two electrolysis systems, a power supply source having a direct voltage output, and a central supply line is provided. The central supply line is connected to the direct voltage output of the power supply source, so that a direct current can be fed into the central supply line and a central DC network designed for high voltage is provided, to which DC network the electrolysis systems are connected by means of the central supply line. The power supply source has, as a power generator, a wind turbine, to which a rectifier having a direct voltage output is connected, the direct voltage output being designed for the high voltage.

### BACKGROUND

The invention relates to a system combination comprising at least two electrolysis systems and a power supply source. The invention also relates to a use.

The electrolysis system is a device which causes substance conversion using electrical power (electrolysis). According to the variety of different electrochemical electrolysis processes, there is also a plurality of electrolysis systems, such as an electrolysis system for water electrolysis, for example.

Nowadays, for example, hydrogen is generated from water by means of proton exchange membrane (PEM) electrolysis, anion exchange membrane electrolysis or alkaline electrolysis. The electrolysis systems produce hydrogen and oxygen from the supplied water by means of electrical energy. This process occurs in an electrolysis stack consisting of multiple electrolysis cells. Water, as a reactant, is introduced into the electrolysis stack energized with a direct current (DC) voltage, wherein two fluid flows, consisting of water and gas bubbles (O₂ and H₂), exit the electrolysis cells after having passed therethrough.

Current considerations are focused on generating recyclable materials using excessive energy from renewable energy sources at times of lots of sunshine and wind, i.e., of outstanding solar energy or wind energy generation. In particular, a recyclable material may be hydrogen generated by water electrolysis systems. For example, based on hydrogen, what is known as renewable energy gas—also referred to as RE gas—may be generated. An RE gas is a combustible gas obtained from renewable sources by means of electrical energy.

Hydrogen is a particularly environmentally friendly and sustainable energy carrier. It has the unique potential of realizing energy systems, traffic and large parts of chemics without CO₂ emissions. In order to achieve this, the hydrogen, however, must not be derived from fossil sources, but must be produced by means of renewable energy. Currently, at least an increasing portion of the power generated from renewable sources is fed into the public power grid. According to the mixture of energy, a respective portion of green hydrogen may be generated when an electrolysis system is operated using power from the public grid.

In performing industrial scale electrolysis, the direct current is provided mainly by means of line-commutated rectifiers. Rectifying mains-side alternating current voltage may cause harmonics due to the functionality of the rectifiers, which may load the alternating current network and/or the direct current network.

EP 3 723 254 A1 discloses such an electrolysis system connected to the public power grid and operated accordingly with grid power. The electrolysis system has a circuity comprising four coil assemblies and four rectifiers. The first coils of the coil assemblies are each connected to the DC voltage side of a rectifier. The circuitry further comprises two transformers, each having a primary winding as well as two secondary windings. The primary windings of the transformers are connected with the power grid, e.g., a medium voltage grid or a high voltage grid. Despite the reduced iron content, this allows for a desired smoothing of the direct current and dampening of the harmonics, respectively, within the first coil.

The increasing use of wind power provides a source of renewable energy. In particular, wind turbines near the coast, so-called offshore wind turbines, allow for providing large amounts of electrical power. However, spanning large distances to the consumers is challenging. Therefore, the energy should be transported to the consumer with as little loss as possible. Hydrogen is highly suitable as transport medium and energy carrier. For example, it may be transported in gaseous form through pipelines. A positive side effect is that a hydrogen carrying pipeline may simultaneously function as an energy storage as the internal pressure may be varied to a certain extent.

Based on these considerations, producing the hydrogen directly at the site of energy generation, i.e., autonomously and independently from the public grid, is of particular economical interest. To this purpose, electrolysis systems on offshore platforms in maritime areas are proposed to be installed on offshore wind turbines directly or in close proximity and to be supplied electrically with the power generated.

Concepts for immediately utilizing power from onshore wind turbines or photovoltaic systems at least partly by directly connecting to and feeding into an electrolysis system for generating hydrogen have also been proposed for the mainland. In all of these applications, the electrolysis system is part of a so-called microgrid. Thus, the electrolysis current is not obtained from the public grid, but is rather delivered directly by a wind turbine or a PV system and fed into an electrolyzer of the electrolysis system. The electric energy generated by a wind turbine or a PV system may also be buffered in a battery, for example. Contrary to the line-commutated operation described above, this gives rise to particular challenges and issues regarding electrotechnically connecting and interconnecting the electrolysis system to the respective RE generating system, be it a wind turbine or a photovoltaic system, particularly to ensure a secure and especially failure-free operation of the electrolysis in a system combination with the RE generating system.

In both line-commutated operation and microgrid operation, there is a high need for technical solutions to allow for reliably and at the same time inexpensively connecting one or more electrolysis systems to the respective power generator. This is all the more the case as increasingly very large and complex electrolysis systems or electrolysis assemblies having a plurality of electrolyzers need to be supplied simultaneously and be connected accordingly to an external power source. This gives rise to challenges of transferring power in an inexpensive manner from the respective power supply source to the electrolysis systems which are interconnected in these combined systems forming a partly complex system combination.

### SUMMARY

Therefore, an object of the invention is to provide a system combination which allows for electrolysis systems being electrically connected to and supplied by a power supply source as reliably and inexpensively as possible, wherein a high operational flexibility is achieved particularly regarding partial load operation of the electrolysis systems.

This object is achieved according to the invention by a system combination, comprising at least two electrolysis systems, a power supply source having a DC voltage output, and a central supply line, wherein the central supply line is connected to the DC voltage output of the power supply source, so that a direct current can be fed into the central supply line, and a central DC network designed for high voltage is provided, to which DC network the electrolysis systems are connected by means of the central supply line, wherein the power supply source has, as a power generator, a wind turbine, to which a rectifier having a DC voltage output is connected, the DC voltage output being designed for the high voltage, and wherein one electrolysis system is disposed at the base of the tower of the wind turbine and is connected there directly to the central supply line.

The invention has recognized the issues of connection and efficient power transfer when combining occasionally different external power supply sources with electrolysis systems into a system combination. This applies to both microgrid operation and line-commutated operation when the electrolysis systems are connected to the public power grid. Depending on the distance of the electrolyzers of an electrolysis system to be supplied with direct current to the respective power supply source, low voltage power transfer results to high material costs, e.g., of the electrical conductors, to limit the transfer losses. This specifically applies to large physical distances, such as if the generator of a wind turbine is located high up in the nacelle and the electrolysis system is disposed on the ground near the tower or even remotely at a large distance. Even this simple example would readily require several 100 m of cable to be routed to supply an electrolysis system and to connect it to a power supply source. The cable routes and the corresponding use of materials alone result in a significant increase in costs for connecting and supplying the electrolysis systems. Added to this are costs for electrical apparatuses for connecting and transferring power.

Known industrial scale solutions, for example, propose reducing line losses specifically by reducing current and increasing voltage. Transformers are often employed to increase the transfer voltage. They require an AC voltage system, i.e., an AC network, designed for a network operation at a frequency of currently 50 Hz to 60 Hz. The transfer losses across the connection and supply lines are, in fact, reduced due to the selected larger transfer voltage. However, this design also has disadvantages as the transformers are accordingly large in size, weight, and costs.

Also, by combining renewable generating systems (RE systems) having electrolyzers, most of which already providing DC voltage, multiple conversions of the voltage waveform (DC-AC-DC) will result in an increase of losses and costs. Therefore, power conversion during transport from the power supply source to the electrolysis systems should be kept to a minimum of times required.

Particularly with onshore wind and solar power systems, a parallel connection of the wind/solar power plants to the public power grid which is operated with alternating current is necessary. This gives rise to the problem of finding an optimal supply topology accounting for the number of conversions, costs of power distribution, such as material costs for copper and aluminum, network perturbations, and partial load operation of the electrolysis assemblies.

Prior art approaches do not provide satisfying concepts as there is a lack of incorporated solutions. Existing systems are used, which are simply coupled to each other. This results in unnecessary high and, on an industrial scale, economically inacceptable conversion losses in a system combination.

In order to solve the problems of connection and transfer in a system combination having a number of electrolysis systems in an inexpensive and efficient manner, the invention proposes connecting the electrolysis systems by means of a central DC network specifically established for this purpose. This DC network provides the specified high voltage and electrical power in the central supply line and functions as transfer and distribution network for the direct current. The transfer power required is transferred from the power supply source to the electrolysis systems through the central DC network, such that the electrolysis current is available. The high voltage of the higher frequency DC network is flexibly selectable and adjustable to a required DC voltage connection value.

This allows for the DC voltage output of a generator or a solar power system to be output at a suitable high voltage on the specified high voltage and for the direct current power to be fed immediately or by means of a DC/DC converter into the central supply line of the DC network. The specified high voltage being significantly higher than the usual public grid voltage reduces the material required and thus the costs of the lines from the power supply source. Thus, depending on the required connection power for the connected electrolysis systems, for example, DC voltages of several kilovolts up to 100 kV and corresponding transfer powers are possible, for which the DC network is designed and which are provided at the supply terminal of the supply line.

In exemplary embodiments, the invention allows for spanning even larger line distances between the power supply source and the electrolysis systems in a particularly inexpensive manner without requiring AC conversions for boost and buck transformations to be performed again. This would require multiple transformers, resulting in an increase in costs. This makes a microgrid operation and corresponding direct DC connection of the electrolysis systems particularly in remote areas economically feasible, such as in case of remote onshore wind turbines. There is a flexibility in transfer distances of several kilometers up to several 100 km.

The high voltage network on the central supply line can be flexibly designed, adjusted and controlled regarding power supply source, DC voltage level, transfer and distribution path and drain power of the connected electrolysis systems to the respective case of application. This allows for an immediate supply and direct current connection of a respective electrolysis system as well as for a partial load operation wherein, in comparison to an AC intermediate circuit, conversion losses are avoided. The number of transformers may be reduced. By means of the power supply source, a direct current may be fed at the DC voltage output into the central supply line. The electrolysis systems in the system combination are each connected to the central supply line and obtain the electrical DC power for the electrolysis process from the central DC network.

This results in any number of electrolysis systems being connected in a particularly advantageous manner to the power supply source by means of the central supply line, wherein the central DC supply line functions as a DC bus line in the system combination. An advantage is that the DC power may be transferred with particularly little losses even across larger distances. Compared to conventional connections and design for an available alternating current network frequency, this allows for a reduction particularly in material costs for lines and numerous connecting transformers, as well as installation space for the system components. In order to ensure a corresponding connection power, it is also possible for one or more DC strands routed electrically in parallel, in particular, to be present, which form the central supply line according to the present invention.

The concept including the central DC supply line is simply scalable and very flexible regarding the number of electrolysis systems supplied by means of the DC network and the type of the power supply source The DC network on the central supply line further creates a disengagement or independence regarding the potential types of generation of the electrical power fed into the central supply line. In this way, the system combination can be designed for microgrid operation or can be connected to a public grid. Advantageous combinations are also possible, as well as obtaining from different power supply sources, such as wind energy, photovoltaics or water power.

In the system combination of the invention, it is provided for the power supply source, as a power generator, to have at least a wind turbine, to which a rectifier having a DC voltage output is connected, the DC voltage output being designed for the high voltage.

In this way, by means of the central DC supply line, a connection or DC connection and supply of the electrolysis system by a wind turbine is achieved in the system combination, wherein microgrid operation is possible and may be advantageous. If operated in a microgrid, the system combination is not connected to the public power grid. Thus, the network frequency of the public power grid of 50 Hz to 60 Hz is insignificant for the design and operation of the electrical components in the frequency-independent DC network. In particular, there are not any costs for components and conversion losses, for example transformers, or for the required inversion, transfer or re-rectification. This results in reduced costs while maintaining flexibility in designing and selecting the connecting components in the DC network. Frequency-independent operation is achieved by means of the central supply line designed as a DC bus.

Thus, it is possible and may be advantageous to span larger distances and line paths between the power generators and the electrolysis systems in an inexpensive manner without requiring another AC conversion for boost and buck transformations to be performed again, which may only be accomplished by means of multiple transformers.

Furthermore, independently controlling or engaging and disengaging preferably employed DC/DC converters allows for the electrolysis systems to be adjusted highly accurately to the (varying) power output of the power generator. If a single electrolysis system falls under a critical threshold of the power input, the hydrogen gas concentration on the oxygen side will experience an unacceptable increase such that there may be a risk of explosion. Thus, critical conditions may be avoided and a secure partial load operation is made possible.

The invention also proposes disposing an electrolysis system in the system combination at the base of the tower of a wind turbine and connecting it there directly to the central supply line for direct current. For remote onshore wind turbines, it is particularly advantageous for an electrolysis system in the system combination to be connected to the DC bus line near the wind turbine. Then, if preferably DC/DC converters are employed, the interconnect line is designed with high DC voltage such that use of material, such as copper and aluminum, in particular, is reduced and the manufacturing costs are lowered correspondingly.

In an exemplary design of the system combination, the electrolysis systems are connected in parallel to each other relative to the central supply line, wherein an electrolysis system is connected to the central supply line by means of a respective connecting line.

This shows the advantages of the DC bus principle having the central DC supply line, which allows for a respective independent connecting line for an electrolysis system and actually provides the same. In the system combination, the central DC supply network can be developed flexibly, if required, and expanded by further electrolysis systems, possibly by adjusting the feed power of the power supply sources feeding into the DC network regarding the required drain power of the electrolyzers.

In an exemplary embodiment, a down converter is connected in a connecting line, the input voltage of which corresponds to the high voltage in the central DC network and the output voltage of which is designed for a respective operating voltage of the electrolysis system.

Employing possibly multiple high voltage DC/DC converters connected in parallel in a connecting line and having a modular design is particularly advantageous. This allows for an industrial application in combination in a system combination having an electrolysis system.

The down converter converts an input voltage to a lower output voltage. It is also referred to as a buck converter or step-down converter.

A connecting line forms a central DC strand or a DC branch from the central supply line for one or more electrolysis systems or electrolyzers operable with direct current. Thus, any number of electrolysis systems having any size can be connected at one or more such central DC branches, advantageously by means of controllable DC/DC converters, particularly so-called buck converter or down converter.

The DC/DC converters individually lower the DC voltage to the desired values without significant conversion losses. Thus, in the system combination, the electrolysis systems can both be controlled regarding the electrolysis power and be engaged and disengaged. A partial load operation or partial load activation is achieved by controlling the electrolysis current. The microgrid capability is ensured by adapting the power controls, which results in significant cost benefits with remote onshore systems or offshore systems. In order to provide higher electrolysis currents, if needed, multiple DC/DC converters may be connected in parallel and employed in a connecting line.

Therefore, in an exemplary design, the down converter is configured as a controllable buck converter, such that the supply of electrolysis current to the electrolysis system is adjustable to a varying feed power of the power supply source to the central supply line.

The buck converter being controllable allows for a flexible and, regarding the electrolysis power, adjustable supply of the electrolysis system in a connecting line with electrolysis direct current. Whether the operation of the down converter is continuous or discontinuous depends on inductivity, switching frequency, input voltage, output voltage, and the flowing output current. As these parameters may change quickly, the transition between the two modes of operation generally needs to be accounted for (e.g., prevented) when designing the circuitry, in particular when designing a controller. The two modes of operation differ from each other regarding the control characteristic, i.e., the output voltage depending on the duty cycle (see below), as well as in respect to the electromagnetic interference.

In an exemplary embodiment, the down converter is a controllable buck converter controlling the output voltage using a pulse width modulation method in continuous operation. In this way, a continuous operation of the buck converter is achieved and the electrolysis current supplied to the electrolysis system may be controlled.

In an exemplary embodiment, the wind turbine in the system combination is configured without a mechanical transmission—i.e., transmission-less—and is designed for operation with variable rotor frequency, wherein the wind turbine has a generator, the alternating current output of which is connected to the input of the rectifier.

In an exemplary embodiment, the power supply source has, as a power generator, a photovoltaic system having a DC voltage output, the DC voltage output being designed for the high voltage, and wherein the DC voltage output is connected to the central supply line.

This allows for the DC voltage level at the DC voltage output to be flexibly adapted to the specified high voltage on the central DC supply line. If needed, up converters, so-called boost converters, are connected downstream of the PV generator for adjusting the specified DC voltage level at the DC voltage output. This is required when the DC output of the photovoltaic system itself does not provide a sufficiently high DC voltage level to be fed into the central supply line.

This design achieves an advantageous coupling or connection and supply of the electrolysis system in the system combination by means of the central DC network on the supply line with power obtained from a photovoltaic system. A microgrid operation based on photovoltaics is possible. In an analogous example and corresponding to the advantages similar to the connection described above of the electrolysis system to a wind turbine, the operation in a microgrid is independent from the public grid frequency, which particularly allows for a high design flexibility and autonomous applications remote from the public power grid. Thus, the network frequency of the public power grid of 50 Hz to 60 Hz is insignificant for the design and operation of the electrical components within the DC network. Here, at most, a boost converter (DC/DC converter) is required for providing an increase in voltage of the PV generator as needed to cause direct current to be fed precisely at the specified high voltage into the central supply line.

In an exemplary embodiment, the power supply source has, as a power generator, a water power plant including a generator, wherein a rectifier having a DC voltage output is connected to the generator.

It is possible and advantageous to employ a generator in a water power plant, which already outputs a frequency directly at the generator output which is higher than the network frequency. Thus, the generator of the water power plant may be advantageously designed for the frequency of the AC voltage input of the rectifier. Conversely, the rectifier may be selected and flexibly adapted to the respective output frequency of the generator of the water power plant. This low complexity and number of components may result in additional cost benefits when being connected to the water power plant, wherein a microgrid operation of the system combination is possible as well. Using the pole number and rotational speed, the output speed, and thus the alternating current frequency of the generator, may be calculated. Thus, in particular, generators for water power plants are available for a higher frequency alternating current output, such that a corresponding rectifier having an input designed for a higher frequency is employed in the system combination. Advantageously, this allows for a network-independent operation, i.e., without needing to account for the network frequency of the public power grid. A frequency-adapted coupling, for example by means of expensive and large transformers, is not required in the central DC network or may be omitted.

In an exemplary embodiment, the power supply source is formed by the public power grid, wherein a rectifier is provided, the DC voltage output of which is designed for the high voltage of the central supply line.

This allows in the system combination for a network terminal to be provided, if needed and of advantage, by means of which a network current rectified by the rectifier can be fed into the central supply line at the specified high voltage. The network terminal is advantageously configured for a bidirectional operation, such that it is also possible for electrical power from the central supply line to be fed into the public grid. This network feed into the public power grid may be required to discharge the power in a productive manner in the event of a reduced drain power of the electrolysis systems or of a potentially temporary excess production of RE power on the side of the power generator systems, i.e. a wind turbine, a photovoltaic system or a water power plant.

It is also possible and advantageous for the power generation source in the system combination to be formed or fed by combinations of different power generators, such as wind turbines, photovoltaic systems or water power plants, which are connected to the central supply line by means of a respective DC voltage output.

Therefore, the system combination is designed and configured for being connected, if needed, to the public power grid. Thus, it is also possible for the network to be operated in a microgrid operation. If a connection to the public power grid is considered, it is also possible and to be preferred that the rectifier, as a central rectifier, e.g. as a central rectifier station, is designed as having a corresponding performance so as to omit components and provide a central connecting point for draining and rectifying grid power. This type of central connection to the public power grid by means of a central rectifier may be particularly easily realized at the grid connection point of a wind turbine or a wind park, for example, wherein a bidirectional use is provided. When feeding into the central supply line, a rectification of grid power is performed, and when feeding into the public power grid, an inversion of direct current from the central supply line drawn from the DC network is performed.

For example, if a wind or solar park is to be connected additionally to the public power grid, a grid connection of the central DC network formed by the central supply line may be realized using the provided additional rectifier and inverter, respectively. The voltage level of the DC strands may be flexibly selected, such that no additional transformer is needed for the connection to the power grid. The rectifier and the inverter, respectively, may control the voltage on the output side in the DC strand independently by either receiving additional power from the grid or feeding excessive power into the grid.

In an exemplary embodiment, this rectifier and inverter based on IGBT (insulated gate bipolar transistor), respectively, is configured as bipolar, as in this case, the network perturbations are low, allowing for omission of filters and reactive power compensation systems. In addition, grid services may be provided. This is particularly advantageous when connecting to low performance networks, for example by means of a long branch line.

An IGBT is a part often used in power electronics, as it combines advantages of the bipolar transistor, such as good transmission behavior, a high cut-off voltage, robustness and advantages of a field effect transistor with an almost no-power control. The distinctive advantages of IGBTs include high voltage and current limits with operating voltages of up to 6,500 V and currents of up to 3,600 A at a performance of up to 100 MW. This allows for an ideal employment of the IGBT in the rectifier 15 for the working range of the electrolyzer. Depending on the application, the use of a so-called IGCT, i.e. integrated gate-commuted thyristor, may also be considered. It has a reduced circuitry, increased maximum pulse frequencies for control, as well as improved response time when connected in series, which is an advantage. Applications of IGCTs are high performance rectifiers. A single module typically switches several kiloamperes at a typical cut-off voltage of 4,500 V.

In an exemplary embodiment, the power supply source has an up converter having a DC voltage output, by means of which a specified high voltage for the central supply line can be provided.

The up converter, also referred to as boost converter or step-up converter, designates a form of a DC voltage converter in the field of electronics. The amount of the output voltage is always greater than the amount of the input voltage. This allows for the DC voltage level at the DC voltage output to be flexibly adapted to the specified high voltage on the central DC supply line. The use of a boost converter is advantageous, particularly in conjunction with a PV generator as a power supply source, wherein the PV DC voltage is boosted, such that the specified high voltage for being fed into the central supply line is provided at the DC voltage output.

Another aspect of the invention relates to the use of a DC network in the system combination described, wherein a number of electrolysis systems is connected to a central supply line for direct current, and wherein a direct current is fed, at a specified connection value for the high voltage, into the central supply line by means of a DC voltage output.

In use, a high voltage direct current at a specified high voltage significantly above the network voltage is provided at the terminals of the central supply line. Thus, the electrolyzers of the electrolysis systems connected to the central DC bus line can be individually supplied centrally by means of a DC network.

In use, the specified high voltage in the central supply line is preferably provided by an up converter having a DC voltage output at an output voltage above 1.5 kV, particularly above 10 kV.

In use, the central supply line is operated particularly preferably with a DC voltage at a high voltage of 10 kV to 110 kV, preferably 30 kV to 60 kV.

The central DC strand mostly eliminates the employment of transformers compared to a supply based on alternating current. The use of material and installation space due to the weight and size of required transformers in case of an AC grid connection may be significantly reduced following designing and defining a central high voltage direct current supply network. This reduces the use of material particularly regarding iron and copper, which in turn requires less installation space.

The invention may be employed for connecting or electrically connecting preferably onshore wind turbines to electrolysis systems in a system combination. There, in conventional applications, upon connection to the AC network, the generator power is typically brought to a constant output frequency of 50 Hz by means of an inverter (AC-DC-AC), in order for the wind turbine to be connected without a mechanical transmission-as a so-called “transmission-less” wind turbine-and variable rotor frequency. If an electrolysis system is to be connected, it may now be connected directly to the central DC supply line (DC bus line), e.g., simply at the base of the tower. Since DC/DC converters are used, the interconnect line may be designed with high voltage, to reduce material, such as, in particular, copper and aluminum, and to lower the costs.

By connecting multiple electrolysis systems in parallel, each comprising electrolyzers connected in series, a good partial load operation of the entire electrolysis assembly may be achieved at the central DC supply line. If needed, the power of the wind turbine may be transferred to the AC network. This may be the case if the electrolysis system has a failure, the electrolyzers of the electrolysis system are being maintained, or if the electrolysis is not designed for the peak power of the wind turbine.

In an application in a microgrid, a network-side converter can be omitted and a connection to the central supply line by means of a respective connecting line is established between the generator and a respective electrolysis system having the electrolyzers using the same principle. In this case, the need for transformers is significantly reduced. Even only optionally as needed, a maximum of one transformer comparatively small in size but high in frequency is needed for galvanic disengagement to ensure an inexpensive connection of the electrolysis to the generator at a high voltage.

Advantages and advantageous embodiments of the system combination of the invention are to be considered as advantages and advantageous embodiments of the corresponding use and vice versa.

Further advantages, features and details of the invention will be apparent from the following description of various embodiments as well as from the drawing. The features and combinations of features mentioned above in the description, as well as the features and combinations of features mentioned in the following description of figures and/or shown only in the individual figures can be used not only in the respective indicated combination, but also in other combinations or individually without departing from the scope of the invention.

### BRIEF DESCRIPTION OF THE DRAWINGS

Embodiments of the invention are explained in detail in reference to a drawing. In a schematic and highly simplified manner:

FIG. 1 shows a system combination having an electrolysis system and a wind turbine;

FIG. 2 shows a system combination having an electrolysis system and a photovoltaic system.

In the figures, like reference numerals have like meaning.

### DETAILED DESCRIPTION

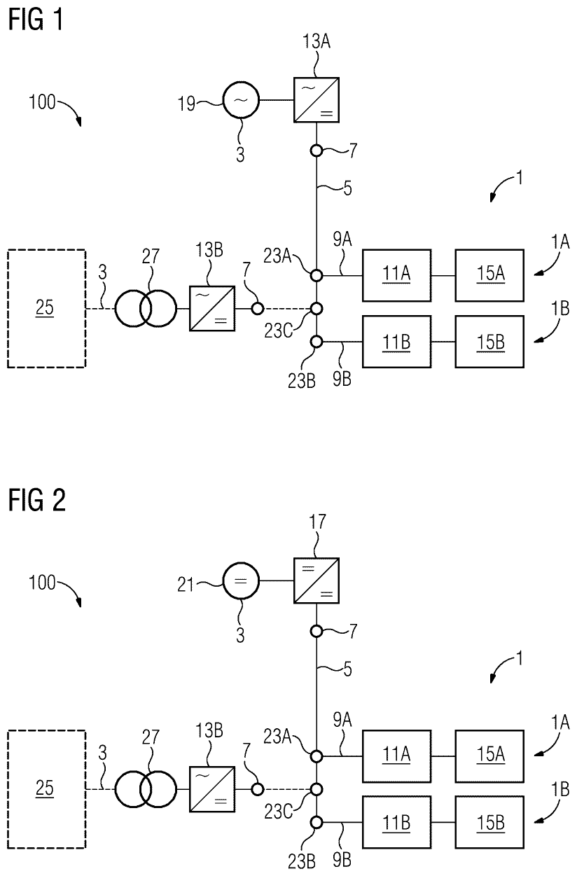

In FIG. 1 shows a system combination 100 according to the invention. The system combination 100 comprises an electrolysis assembly 1 having two electrolysis systems 1A, 1B, and a power supply source 3 connected to the electrolysis assembly 1. The power supply source 3 has, as a power generator, a wind turbine 19 functioning as a renewable energy (RE) system and a source for green power. The electrolysis assembly 1 is supplied with electrolysis current by means of a central supply line 5, to which a DC voltage is applied, the central supply line 5 forms a central DC bus line by means of which direct current for electrolysis processes can be delivered to the electrolysis assembly 1.

Each of the electrolysis systems 1A, 1B of the electrolysis assembly 1 is connected to the central supply line 5 by means of a respective connecting line 9A, 9B at a supply terminal 23A, 23B, such that a parallel connection of the electrolysis systems 1A, 1B is realized. The electrolysis system 1A has at least one electrolyzer 15A, and the electrolysis system 1B has at least one electrolyzer 15B. The electrolyzers 15A, 15B can selectively be designed as a PEM electrolyzer, AEM (anion exchange membrane) electrolyzer or alkaline electrolyzer, wherein combinations are also possible. It is possible that a plurality of electrolyzers 15A, 15B in a strand of the respective electrolysis system 1A, 1B to be supplied by means of the corresponding connecting line 9A 9B is connected in series.

On the side of the power supply source 3, a rectifier 13A having a DC voltage output 7 is connected downward of the wind turbine 19 on the output of a generator of the wind turbine 19. Thus, an alternating current generated by the generator of the wind turbine 19 can be converted to a direct current and can be fed at a specified high voltage at the DC voltage output 7 into the central supply line 5. This realizes a central DC network designed for high voltage. For coupling the power generated by the wind turbine 19 and fed into the central supply line, no further active components, such as transformers, are required upon connecting the wind turbine 19 to the central supply line 5, such that a particularly simple supply topology is realized.

The DC voltage level at the DC voltage output 7 of the rectifier 13A can be flexibly adjusted to the respective requirement in the system combination 100, wherein a high output voltage is selected as a specified high voltage, preferably being above 1.5 kV. Upon designing and constructing the central DC network by means of the central supply line 5, reference can also be made to the nominal voltages of the common network levels used in transferring power, or these values can function as reference for the DC voltage level. Electrical energy in high voltage lines on different network levels of medium voltage and high voltage are transferred at the following common nominal voltages: Medium voltage of 3 kV, 6 kV, 10 kV, 15 kV, 20 kV, 30 kV; high voltage of 60 kV, 110 kV. As an advantage, the central supply line 5 functions as a central DC bus line, which allows for immediately supplying an electrolysis assembly 1 with high voltage based direct current.

For connecting and supplying the electrolysis systems 1A, 1B with direct current in a manner adapted to the operating voltage, a down converter 11A is connected in the connecting line 9A, and a corresponding down converter 11B is connected in the connecting line 9B. The input of the down converter 11A is connected by means of the supply terminal 23A and, accordingly, the input of the down converter 11B is connected by means of the supply terminal 23B to the central supply line 5. The down converters 11A, 11B are each connected to the electrolyzer 15A, 15B in the connecting line 9A, 9B on the output side, such that a respective direct current at an adjustable voltage level for the operating voltage is provided for the electrolysis in the electrolyzers 15A, 15B. When operating the system combination 100, a high voltage DC network is provided as a central DC network on the central supply line 5 and is used to supply the electrolysis systems 1A, 1B connected in parallel to the central supply line 5 with electrolysis current. Employing a high voltage allows for a direct current to be provided, a higher frequency alternating current to be provided and fed into the central supply line 5. The system combination 100 can be designed as particularly flexible or expandable by connecting, for example, further electrolysis systems 1A, 1B comprising further electrolyzers 15A, 15B by means of a connecting line 9A, 9B. The system combination 100 advantageously provides for a network-independent microgrid operation.

The down converters 11A, 11B connected in the connecting line 9A, 9B are realized as DC/DC converters (buck converters) and each designed such that their input voltage corresponds to the specified high voltage in the central DC network on the central supply line 5, and the respective output voltage of which is adjusted or set to a respective operating voltage of the electrolysis system 1A, 1B. The down converters 11A, 11B are configured as controllable buck converters, such that the supply of electrolysis current to the electrolysis system 1A, 1B is adjustable to a varying feed power of the power supply source 3 into the central supply line 5 and can be tracked. For example, the down converters 11A, 11B can be configured as controllable buck converters controlling the output voltage using a pulse width modulation method in continuous operation, allowing for continuous operation with particular performance.

In the system combination 100 shown in FIG. 1, it is also possible for an electrolysis system 1A, 1B to be disposed at the base of the tower of a respective wind turbine 19, for example, and to be connected there directly to the central supply line 5. This is advantageous for onshore applications and installations of wind turbines 19 in remote areas and for microgrid operation. As used herein, wind turbine 19 also means a wind farm or wind park-onshore or offshore-having a plurality of wind turbines 19.

According to the embodiment of FIG. 1, alternatively or additionally, a connection to the public power grid 25 is also possible on the side of the power supply source 3 in the system combination 100. For this, as illustrated in phantom in FIG. 1, a separate supply terminal 23C is provided in the central supply line 5. The connection to the public power grid 25 is made by means of a connecting transformer 27 and a downstream rectifier 13B having a DC voltage output 7. The rectifier 13B is designed such that its DC voltage output 7 is designed for the high voltage of the central supply line 5 and will output the specified high voltage at a corresponding voltage level, i.e., selectively, for example, medium voltage levels of 3 kV, 6 kV, 10 kV, 15 kV, 20 kV, 30 kV; or high voltage of 60 kV, 110 kV. The voltage level is flexibly adjustable and changeable. In addition, a bidirectional operation is possible when utilizing the supply terminal 23C as grid terminal, such that feeding direct current from the public power grid 25 into the central supply line 5 as well as out-feeding direct current from the DC network of the central supply line 5 is possible as needed.

Thus, power from the public power grid 25, adjusted to the voltage, can be fed into the central supply line 5 at the supply terminal 23C as needed and is provided for use for electrolysis in the electrolysis assembly 1. An advantage is that by providing a connection to the public power grid 29, for example, replacement demands are met, such as when the wind turbine 19 hardly generates power, if any, due to maintenance, or in phases of dark doldrums, such that a backup solution is required in order to ensure a supply as continuous as possible and smooth operation of the electrolysis systems 1A, 1B for producing hydrogen. If needed, one or more electrolysis systems 1A, 1B can be operated in partial load or disconnected from the DC network if there is a shortage of electrical DC power on the central supply line 5. If needed, an adjusted partial load operation in the respective connecting line 9A, 9B is achieved by the controllable down converters 11A, 11B, by the means of which the DC power can be adjusted via the output voltage at the output of the down converter 11A, 11B. If the system combination is operated entirely in a microgrid operation, it is typically impossible to meet replacement demands due to the lack of available connections to a public grid 29.

In another embodiment of a system combination 100 according to the invention, an alternative power supply source 3 for supplying the electrolysis assembly 1 with direct current is shown in FIG. 2. The power supply source 3 has a photovoltaic system 21 having a plurality of PV modules not shown in detail. For example, the photovoltaic system 21 may be designed as a ground-mounted system having a large surface and high performance—preferably in regions with a lot of sunshine—such that PV powers of 10 MW of electrical power and more can be provided for electrolysis. On the side of the electrolysis assembly 1, a generally analog system concept as in FIG. 1 is applied and corresponding system components are provided, i.e., the electrolysis systems 1A, 1B are electrically connected and supplied by means of the central supply line 5, which, in turn, is designed as a central DC bus line or DC connecting strand. In order to achieve this, the electrolysis system 1A is electrically connected to the supply terminal 23A and, correspondingly, the electrolysis system 1B is electrically connected to the supply terminal 23B, each by means of a connecting line 9A, 9B.

In the system combination 100 configured in such a manner, the power supply source 3, as a power generator, has a photovoltaic system 21, referred to as a PV generator. It already provides a DC voltage at the generator output, which may already be designed for the specified high voltage, wherein the DC voltage output 7 is formed by the PV generator output and is connected immediately to the central supply line 5.

For the photovoltaic system 21, as a power supply source 3, to achieve a desired and advantageous DC voltage level for feeding direct current into the central supply line 5, it is also possible, as shown in the embodiment of FIG. 2, to connect an up converter 17 at the DC output of the generator of the photovoltaic system 21.

The up converter 17, also referred to as boost converter or step-up converter, designates a particular form of a DC voltage converter in the field of power electronics. The amount of the output voltage is always greater than the amount of the input voltage, such that the high voltage of the desired DC voltage level specified for feeding at the DC voltage output 7 is provided by means of the up converter 17. The higher voltage reduces the material required and thus the costs of the lines following feeding by means of the power supply source 3.

The up converter 17 is designed for the voltage level working frequency and provides the specified voltage at the output. The up converter 17 is designed as being controllable, such that a flexible adjustment of the output voltage provided is possible. The connection and feeding of the power of the photovoltaic system 21 into the central supply line 5 is performed immediately at the DC voltage output 7 of the up converter 17. For the electrical power to be transferred and drained by the electrolysis assembly 1, the electrolysis systems 1A, 1B—as described in detail above—are connected to the central supply line 5 by means of a respective connecting line 9A, 9B. The respective down converters 11A, 11B also achieve a disengagement of the control of the electrolysis current demands in the connecting lines 9A, 9B and thus an individual operation of these DC connecting strands, which is important for partial load requirements in particular. In the PV application, it is also possible to feed grid power from the public power grid 23 into the central supply line 5, and this is described in an embodiment analog to FIG. 1.

The invention provides a system combination 100 which can feed electrical power particularly from a renewable power supply source 3 into an electrolysis assembly 1 by means of a number of electrolysis systems 1A, 1B, such that 100% green hydrogen may be generated in the electrolyzers 15A, 15B. This is advantageously done in the described system combination 100 comprising at least two electrolysis systems 1A, 1B, a power supply source 3, and the central supply line 5 designed as a central AC bus line and providing an alternating current at a working frequency above the network frequency of the public grid. A higher frequency AC network is provided and used in the system combination 100, wherein a number of electrolysis systems 1A, 1B is connected to a central supply line 5 and is operated, wherein a higher frequency alternating current is fed into the central supply line 5.

For the operation of the system combination 100, a number of electrolysis systems 1A, 1B is connected to the central supply line 5 for direct current, and wherein a direct current is fed, at a specified high voltage, into the central supply line 5 by means of a DC voltage output 7. A DC network is formed by the central supply line 5 and a central DC network is used as a supply topology for the electrolysis systems 1A, 1B. In a photovoltaic system 21 as a power supply source 3, the specified high voltage in the central supply line may be provided by an up converter 17 having a DC voltage output 7 at an output voltage above 1.5 kV, particularly above 10 kV. The central supply line 5 may also be operated with DC voltage at a high voltage of 10 kV to 110 kV, preferably 30 kV to 60 kV. Specified high voltages may correspond to or be based selectively on, for example, medium voltage levels of 3 kV, 6 kV, 10 kV, 15 kV, 20 kV, 30 kV, or high voltage of 60 kV or 110 kV. The voltage level is flexibly adjustable and changeable, in particular by using controllable DC voltage converters as boost converters 17 and/or down converters 11A, 11B. This also applies to an optional additional connection of the system combination 100 to the public power grid 25 regarding the rectifier 13B, which is advantageously designed as a controllable rectifier 13B, as well as for bidirectional operation.

1. A system combination, comprising at least two electrolysis systems, a power supply source having a DC voltage output, and a central supply line, wherein the central supply line is connected to the DC voltage output of the power supply source, so that a direct current can be fed into the central supply line, and a central DC network designed for high voltage is provided, to which DC network the electrolysis systems are connected by means of the central supply line, wherein the power supply source has, as a power generator, a wind turbine, to which a rectifier having a DC voltage output is connected, the DC voltage output being designed for the high voltage, and wherein one electrolysis system is disposed at a base of a tower of the wind turbine and is connected there directly to the central supply line.

2. The system combination according to claim 1, wherein the electrolysis systems are connected in parallel to each other relative to the central supply line, wherein an electrolysis system is connected to the central supply line by means of a respective connecting line.

3. The system combination according to claim 2, wherein a down converter is connected in the connecting line, an input voltage of which corresponds to the high voltage in the central DC network and the output voltage of which is designed for a respective operating voltage of the electrolysis system.

4. The system combination according to claim 3, wherein the down converter is configured as a controllable buck converter, such that the supply of electrolysis current to the electrolysis system is adjustable to a varying feed power of the power supply source to the central supply line.

5. The system combination according to claim 4, wherein the down converter is configured as a controllable buck converter controlling the output voltage using a pulse width modulation method in continuous operation.

6. The system combination according to claim 1, wherein the wind turbine is configured without a mechanical transmission and is designed for operation with variable rotor frequency, and wherein the wind turbine has a generator, an alternating current output of which is connected to an input of the rectifier.

7. The system combination according to claim 1, wherein the power supply source has, as a power generator, a photovoltaic system, the DC voltage output of which is designed for the high voltage, wherein the DC voltage output is connected to the central supply line.

8. The system combination according to claim 1, wherein the power supply source has, as a power generator, a water power plant including a generator, wherein a rectifier having a DC voltage output is connected to the generator.

9. The system combination according to claim 1, wherein the power supply source is formed by a power grid, wherein a rectifier is provided, the DC voltage output of which is designed for the high voltage of the central supply line.

10. The system combination according to claim 1, wherein the power supply source has an up converter having a DC voltage output, by means of which a specified high voltage for the central supply line can be provided.

11. A use of a DC network in a system combination according to claim 1, wherein a number of electrolysis systems is connected to a central supply line for direct current, and wherein a direct current is fed, at a specified high voltage, into the central supply line by means of a DC voltage output.

12. The use according to claim 11, wherein the specified high voltage in the central supply line is provided by an up converter having a DC voltage output at an output voltage above 1.5 kV, particularly above 10 kV.

13. The use according to claim 12, wherein the central supply line is operated with DC voltage at a high voltage of 10 kV to 110 kV, preferably 30 kV to 60 kV.
